(19) United States
(12) Patent Application Publication
(10) Pub. No.: US 2026/0048461 A1
(43) Pub. Date: Feb. 19, 2026

(54) GAS PRESSURE DRIVING DEVICE, POSITIONING DEVICE, PROCESSING DEVICE, AND DEVICE MANUFACTURING METHOD

(71) Applicant: SUMITOMO HEAVY INDUSTRIES, LTD., Tokyo (JP)

(72) Inventors: Tatsuya YOSHIDA, Yokosuka-shi (JP); Naoto MUROI, Yokosuka-shi (JP)

(21) Appl. No.: 19/327,384

(22) Filed: Sep. 12, 2025

Related U.S. Application Data
(63) Continuation of application No. PCT/JP2024/008220, filed on Mar. 5, 2024.

(30) Foreign Application Priority Data
Mar. 13, 2023 (JP) 2023-038418

(51) Int. Cl. B23Q 5/54; F16C 29/02

(52) U.S. Cl. CPC B23Q 5/54; F16C 29/025

(57) ABSTRACT

A gas pressure driving device includes a first driving shaft that drives a driven body in a first direction by a pressure of a gas, and a second driving shaft that drives the driven body in a second direction intersecting with first direction by the pressure of the gas. The first driving shaft drives the driven body in the first direction by the gas supplied through an inside of the first driving shaft and the second driving shaft.

### CROSS-REFERENCE TO RELATED APPLICATIONS

This is a bypass continuation of International PCT Application No. PCT/JP2024/008220, filed on Mar. 5, 2024, which claims priority to Japanese Patent Application No. 2023-038418, filed on Mar. 13, 2023, which are incorporated by reference herein in their entirety.

### BACKGROUND

### Technical Field

A certain embodiment of the present invention relates to a gas pressure driving device and the like.

### Description of Related Art

The related art discloses a gas pressure actuator used in a vacuum environment, which includes a slider driven along a predetermined movement direction by a gas pressure inside an air servo chamber, and a guide extending in the movement direction to guide the slider. The slider can smoothly move while floating from the guide by an air bearing formed by compressed air supplied between an outer periphery of the slider and an inner periphery of the guide through an air pad.

### SUMMARY

The gas pressure actuator in the related art requires a mechanism for supplying a gas (hereinafter, also referred to as a driving gas) for generating a driving force of the slider or a gas (hereinafter, also referred to as a floating gas) for forming the air pad and/or the air bearing between the slider and a guide, to each part. Since the slider moves relative to the guide, for example, various types of gases are supplied by using a variable tube that can be deformed to follow the movement of the slider. However, it is necessary to consider a design such that the variable tube does not hinder the movement of the slider. Moreover, the variable tube as a movable component or a variable component is likely to deteriorate. Therefore, maintenance work is highly frequently required to prevent contamination of a vacuum environment.

It is desirable to provide a gas pressure driving device or the like which can effectively supply a driving gas.

According to an embodiment of the present invention, there is provided a gas pressure driving device including a first driving shaft that drives a driven body in a first direction by a pressure of a gas, and a second driving shaft that drives the driven body in a second direction intersecting with first direction by the pressure of the gas. The first driving shaft drives the driven body in the first direction by the gas supplied through an inside of the first driving shaft and the second driving shaft.

In this aspect, a gas for generating a driving force of the first driving shaft is effectively supplied through an inside of the first driving shaft and an inside of the second driving shaft.

According to another aspect of the present invention, there is provided a positioning device. The device positions the driven body by the gas pressure driving device.

According to still another aspect of the present invention, there is provided a processing device. The device performs predetermined processing on the driven body positioned by the positioning device.

According to still another aspect of the present invention, there is provided a device manufacturing method. In the method, a device is manufactured through processing performed by the processing device.

Any combination of the above-described components and configurations obtained by converting these expressions into methods, devices, systems, recording media, computer programs, and the like are also included in the present invention.

### BRIEF DESCRIPTION OF THE DRAWINGS

FIG. 1 is a perspective view schematically illustrating a gas pressure actuator.

FIG. 2 is a section view schematically illustrating a basic configuration and operation of an X actuator.

FIG. 3 is a schematic section view of an X servo valve.

FIG. 4 is a section view schematically illustrating a basic configuration and operation of a Y actuator.

FIG. 5 is a ZX section view of the Y actuator.

FIG. 6 is a side view illustrating an inner peripheral surface on a +X side of a Y slider.

FIG. 7 is a side view illustrating an inner peripheral surface on a −X side of the Y slider.

FIG. 8 schematically illustrates a pressure in the ZX section view of the Y actuator.

### DETAILED DESCRIPTION

Hereinafter, a form (hereinafter, also referred to as an embodiment) for carrying out the present invention will be described in detail with reference to the drawings. In the description and/or the drawings, the same reference numerals will be assigned to the same or equivalent components, members, processes, and the like, and repeated description thereof will be omitted. A scale and a shape of each part illustrated in the drawings are set for convenience to simplify the description, and are not limitedly interpreted unless otherwise specified. The embodiment is merely an example, and does not limit the scope of the present invention. All features described in the embodiment and combinations thereof are not necessarily essential to the present invention.

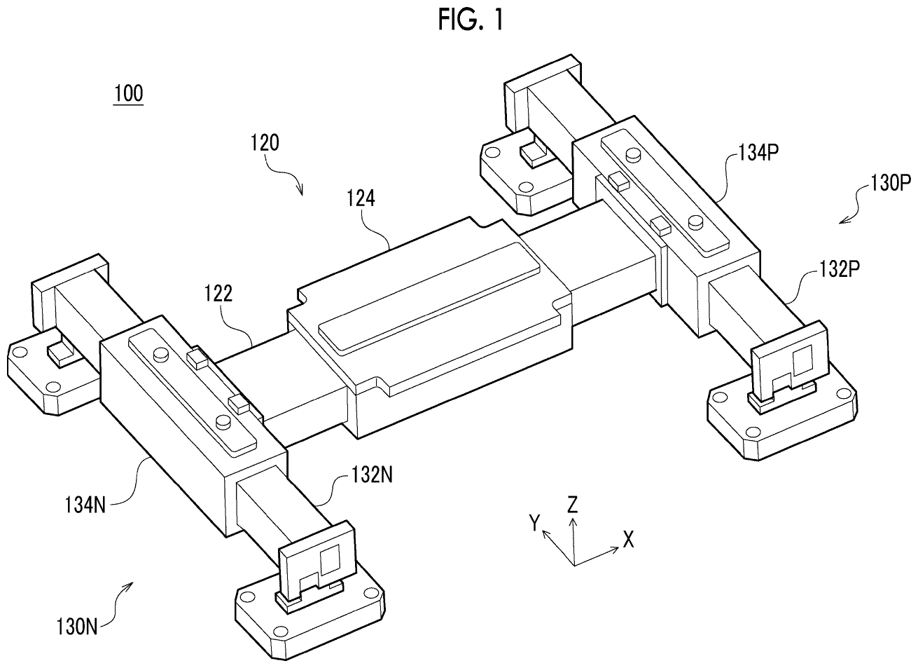

FIG. 1 is a perspective view schematically illustrating a stage device serving as a positioning device or a gas pressure actuator 100 serving as a gas pressure driving device according to an embodiment of the present invention. The gas pressure actuator 100 includes an X actuator 120 that generates a driving force in an X direction serving as a first direction by a pressure of a gas, and a Y actuator 130 that generates a driving force in a Y direction serving as a second direction intersecting with the X direction by the pressure of the gas.

The X actuator 120 includes an X guide 122 serving as a first driving shaft that linearly drives an X slider 124 serving as a driven body in the X direction. The Y actuator 130 includes a Y guide 132 serving as a second driving shaft that integrally and linearly drives a Y slider 134, the X guide 122, and the X slider 124 which serve as driven bodies, in the Y direction. The X direction is an extending direction of the X guide 122. The X slider 124 is guided by the X guide 122, and is linearly driven in the X direction. The Y direction is an extending direction of the Y guide 132. The Y slider 134 is guided by the Y guide 132, and is linearly driven in the Y direction. In an example of the present embodiment, the X direction and the Y direction are perpendicular to each other inside a horizontal plane. In this case, a Z direction (normal direction of an XY plane) perpendicular to the X direction and the Y direction is a vertical direction.

In the present embodiment, a pair of Y actuators 130 are provided in both ends of the X actuator 120 in the X direction. Specifically, a pair of Y sliders 134 are fixed to both ends of the X guide 122 in the X direction. In addition, a pair of Y guides 132 are provided to guide the pair of Y sliders 134 in the Y direction. The X guide 122 and the pair of Y guides 132 have an H-shape in a top view. The pair of Y sliders 134 are linearly driven in the Y direction in the same form by the pair of Y actuators 130 such that positions of the pair of Y sliders 134 in the Y direction are equal to each other, that is, such that the extending direction of the X guide 122 connecting the pair of Y sliders 134 coincides with the X direction. In this way, the pair of Y actuators 130, the pair of Y guides 132, and the pair of Y sliders 134 are respectively substantially the same as each other. Therefore, these are not distinguished from each other in the following description unless necessary. When it is necessary to distinguish between all of these, those which are located on a positive side in the X direction (right side in FIG. 1) will be respectively referred to as a positive side Y actuator 130P, a positive side Y guide 132P, and a positive side Y slider 134P, and those which are located on a negative side in the X direction (left side in FIG. 1) will be respectively referred to as a negative side Y actuator 130N, a negative side Y guide 132N, and a negative side Y slider 134N.

A stage or a table (not illustrated) may be attached to the X slider 124 serving as the driven body. For example, the table is fixed to an upper surface of the X slider 124. Any processing target or a workpiece such as a semiconductor wafer may be placed on an upper surface of the table. The gas pressure actuator 100 in this case forms a part of a positioning device that positions a processing target placed on the table serving as the driven body, and further, forms a part of a processing device that performs any processing on the processing target positioned by the positioning device. Examples of the processing device include a semiconductor manufacturing device or a flat panel display (FPD) manufacturing device such as an exposure device, an ion implanter, a heat treatment device, an ashing device, a sputtering device, a dicing device, an inspection device, and a cleaning device.

The X slider 124, the table, the processing target, and the like which serve as the driven bodies are linearly driven in the X direction along the X guide 122, and are linearly driven in the Y direction along the Y guide 132 integrally with the Y slider 134 and the X guide 122. That is, the X slider 124, the table, and the processing target, and the like which serve as the driven bodies are freely driven in two directions of the X direction and the Y direction while being guided by the X guide 122 serving as the first driving shaft and the Y guide 132 serving as the second driving shaft, and are positioned at any position inside the XY plane (for example, the horizontal plane).

The gas pressure actuator 100 as described above may be used in a vacuum environment such as a vacuum chamber. Here, the vacuum represents a state of a space filled with a gas having a pressure lower than a normal atmospheric pressure. The vacuum is classified into a low vacuum (100 kPa to 100 Pa), a medium vacuum (100 Pa to 0.1 Pa), a high vacuum (0.1 Pa to 10⁻⁵ Pa), and an ultra-high vacuum (10⁻⁵ Pa or lower) depending on a pressure region. The gas pressure actuator 100 according to the present embodiment may be used under the vacuum environment in any classification above, or may be used under a non-vacuum environment. However, as will be described later, according to the gas pressure actuator 100 in the present embodiment, it is possible to avoid use of a variable tube having a risk of contamination in the vacuum environment which is caused by deterioration in supplying the driving gas or the floating gas to the X actuator 120 and the Y actuator 130. Therefore, the gas pressure actuator 100 according to the present embodiment is particularly suitable for use under the vacuum environment having a lower pressure where a higher level of cleanliness is required.

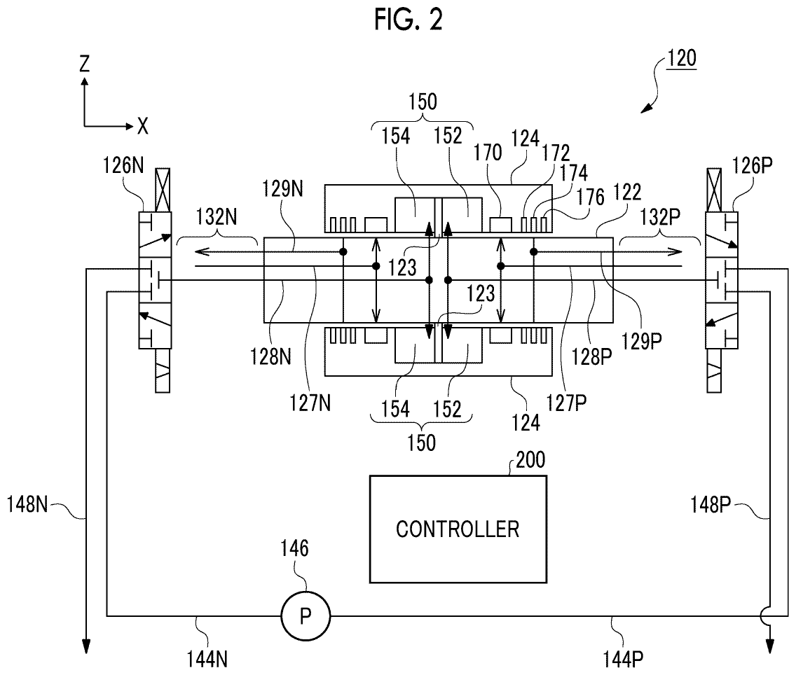

FIG. 2 is a section view schematically illustrating a basic configuration and operation of the X actuator 120. Specifically, a ZX section at the center of the X actuator 120 in the Y direction is schematically illustrated. The X actuator 120 includes an X servo valve 126 that supplies a first driving gas (air or the like) having a pressure commanded by a controller 200 to the X guide 122 and the X slider 124. Specifically, the X servo valve 126 supplies and exhausts the first driving gas to a servo chamber 150 serving as an internal space provided at the center in the X slider 124 in the X direction via a first driving tube 128 provided inside the X guide 122.

The servo chamber 150 is partitioned by a pressure receiving plate 123 fixed to the X guide 122 into a positive side servo chamber 152 on a positive side (right side in FIG. 2) in the X direction and a negative side servo chamber 154 on a negative side (left side in FIG. 2) in the X direction. The X servo valve 126 includes a positive side X servo valve 126P provided on the positive side in the X direction to supply and exhaust the first driving gas to the positive side servo chamber 152, and a negative side X servo valve 126N provided on the negative side in the X direction to supply and exhaust the first driving gas to the negative side servo chamber 154. The positive side X servo valve 126P communicates with the positive side servo chamber 152 via a positive side first driving tube 128P, and the negative side X servo valve 126N communicates with the negative side servo chamber 154 via a negative side first driving tube 128N. The positive side X servo valve 126P and the negative side X servo valve 126N control a supply amount and an exhaust amount of the first driving gas in the positive side servo chamber 152 and the negative side servo chamber 154 in accordance with a position of a spool (to be described later).

The positive side first driving tube 128P and the negative side first driving tube 128N are provided inside the X guide 122. However, as will be described later, the positive side first driving tube 128P and the negative side first driving tube 128N communicate with driving gas relay tubes provided inside the positive side Y guide 132P and the negative side Y guide 132N. For example, the positive side X servo valve 126P and the negative side X servo valve 126N are provided in end portions of the positive side Y guide 132P and the negative side Y guide 132N in the Y direction, and are respectively connected to the driving gas relay tubes. In this way, the positive side X servo valve 126P supplies and exhausts a positive side first driving gas to the positive side servo chamber 152 via the positive side driving gas relay tube inside the positive side Y guide 132P and the positive side first driving tube 128P inside the X guide 122. Similarly, the negative side X servo valve 126N supplies and exhausts a negative side first driving gas to the negative side servo chamber 154 via the negative side driving gas relay tube inside the negative side Y guide 132N and the negative side first driving tube 128N inside the X guide 122.

The controller 200 controls the positive side X servo valve 126P and the negative side X servo valve 126N to generate a differential pressure (pressure difference) between the positive side servo chamber 152 and the negative side servo chamber 154. The X slider 124 is driven in the X direction along the X guide 122 by this differential pressure.

The positive side X servo valve 126P and the negative side X servo valve 126N are respectively connected to a pump 146 serving as a supply source of air (positive side first driving gas and negative side first driving gas) via a positive side air supply tube 144P and a negative side air supply tube 144N. In addition, the positive side X servo valve 126P and the negative side X servo valve 126N respectively exhaust the air (positive side first driving gas and negative side first driving gas) outward of a vacuum chamber (not illustrated) that accommodates the gas pressure actuator 100 via a positive side exhaust tube 148P and a negative side exhaust tube 148N.

The positive side first driving gas from the pump 146 is supplied to the positive side servo chamber 152 via the positive side air supply tube 144P, the positive side X servo valve 126P, the positive side driving gas relay tube inside the positive side Y guide 132P, and the positive side first driving tube 128P inside the X guide 122. Similarly, the negative side first driving gas from the pump 146 is supplied to the negative side servo chamber 154 via the negative side air supply tube 144N, the negative side X servo valve 126N, the negative side driving gas relay tube inside the negative side Y guide 132N, and the negative side first driving tube 128N inside the X guide 122.

The positive side first driving gas inside the positive side servo chamber 152 is exhausted outward of the vacuum chamber via the positive side first driving tube 128P inside the X guide 122, the positive side driving gas relay tube inside the positive side Y guide 132P, the positive side X servo valve 126P, and the positive side exhaust tube 148P. Similarly, the negative side first driving gas inside the negative side servo chamber 154 is exhausted outward of the vacuum chamber via the negative side first driving tube 128N inside the X guide 122, the negative side driving gas relay tube inside the negative side Y guide 132N, the negative side X servo valve 126N, and the negative side exhaust tube 148N. The positive side X servo valve 126P and the negative side X servo valve 126N may be provided outside the vacuum chamber.

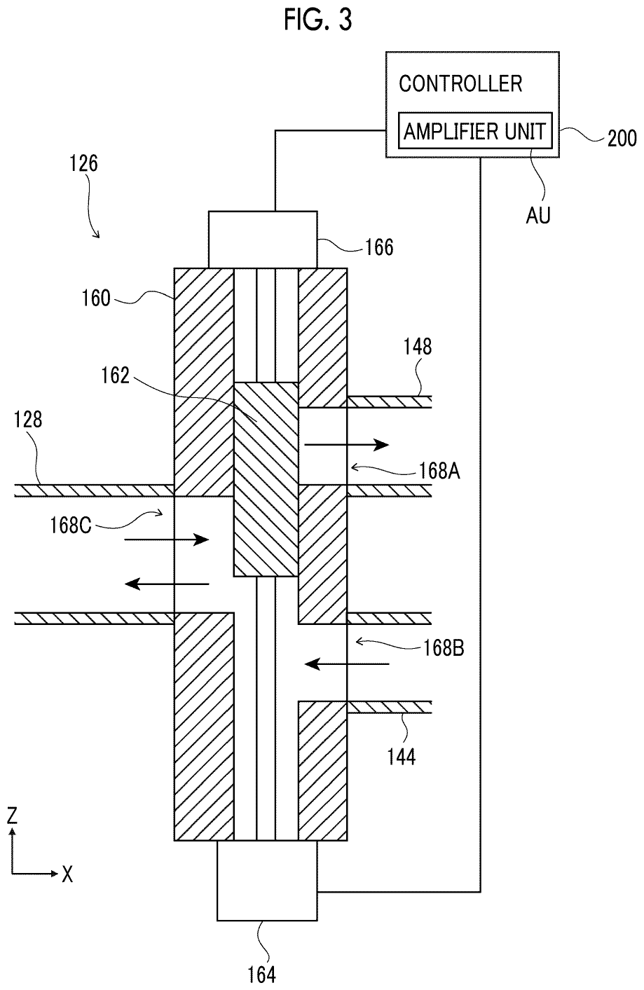

FIG. 3 is a schematic section view of the X servo valve 126 (positive side X servo valve 126P or negative side X servo valve 126N). The X servo valve 126 which is a three-way valve having three ports 168A, 168B, and 168C includes a main body 160, a spool 162 disposed inside the main body 160, a motor 164, and a position sensor 166. The X servo valve 126 switches a connection destination of the port 168C between the port 168A and the port 168B, depending on position of the spool 162. The spool 162 disposed in a flow path in the Z direction inside the main body 160 is driven in the Z direction by the motor 164. The position sensor 166 measures the position of the spool 162 in the Z direction.

In the two ports 168A and 168B aligned along the Z axis on one side surface of the main body 160, the port 168A on a +Z side is connected to the exhaust tube 148 (148P or 148N), and the port 168B on a −Z side is connected to the air supply tube 144 (144P or 144N). The port 168A may be connected to the air supply tube 144, and the port 168B may be connected to the exhaust tube 148. The port 168C provided on the other side surface of the main body 160 is connected to the first driving tube 128 (128P or 128N) inside the X guide 122 via the driving gas relay tube inside the Y guide 132 (132P or 132N).

A measurement result of the position of the spool 162 which is obtained by the position sensor 166 is supplied to an amplifier unit AU of the controller 200. The controller 200 controls the motor 164, based on the position of the spool 162 which is detected by the amplifier unit AU. When the motor 164 controls the position of the spool 162 in the Z direction under the control of the controller 200, the connection destination of the port 168C is switched between the port 168A and the port 168B. When the port 168C is connected to the port 168A, the first driving gas inside the servo chamber 150 is exhausted outward of the vacuum chamber through a flow path between both the ports. In addition, when the port 168C is connected to the port 168B, the first driving gas supplied from the pump 146 is supplied to the servo chamber 150 through a flow path between both the ports.

In FIG. 2, an air pad 170 serving as a static pressure bearing is formed between an outer peripheral surface of the X guide 122 and an inner peripheral surface of the X slider 124 such that the X slider 124 can smoothly move along the X guide 122 in the X direction. The air pad 170 is formed in such a manner that the first floating gas such as compressed air supplied through the first floating tube 127 provided inside the X guide 122 serving as the first driving shaft is always supplied between the outer peripheral surface of the X guide 122 and the inner peripheral surface of the X slider 124. The X slider 124 floated from the X guide 122 by the air pad 170 can smoothly move without being substantially in-contact with the X guide 122.

A plurality of the air pads 170 are provided at positions where the servo chamber 150 provided at the center of the X direction of the X slider 124 is pinched from both the positive and negative sides in the X direction and/or the Y direction. In addition, the servo chamber 150 schematically illustrated in FIG. 2 actually extends over a stroke of the X slider 124 in the X direction, and may be pinched from both the positive and negative sides in the Y direction by the pair of air pads 170 similarly extending in the X direction. In addition, the plurality of air pads 170 are provided at positions where the X guide 122 is pinched from both the positive and negative sides in the Z direction. The rotation of the X slider 124 around the Y axis is effectively suppressed by a symmetrical disposition of the plurality of air pads 170 in the X direction and the Z direction.

The first floating tube 127 includes a positive side first floating tube 127P and a negative side first floating tube 127N. The positive side first floating tube 127P and the negative side first floating tube 127N are provided inside the X guide 122. However, as will be described later, the positive side Y guide 132P and the negative side Y guide 132N communicate with floating gas relay tubes provided inside the positive side Y guide 132P and the negative side Y guide 132N. The floating gas relay tubes are connected to a pump (pump 146 may be shared) (not illustrated) serving as a supply source of the first floating gas, which is the same as the pump 146 serving as a supply source of the first driving gas.

In this way, the positive side first floating gas from a pump (not illustrated) is supplied to the air pad 170 on the positive side in the X direction via the positive side floating gas relay tube inside the positive side Y guide 132P and the positive side first floating tube 127P inside the X guide 122. Similarly, the first floating gas on the negative side from a pump (not illustrated) is supplied to the air pad 170 on the negative side in the X direction via the negative side floating gas relay tube inside the negative side Y guide 132N and the negative side first floating tube 127N inside the X guide 122.

The first floating gas may be supplied from the floating gas relay tube on any one of the positive side and the negative side and the first floating tube 127 to the air pads 170 on both the positive side and the negative side. For example, the first floating gas from a pump (not illustrated) may be supplied to the air pads 170 on both the positive side and the negative side via the positive side floating gas relay tube inside the positive side Y guide 132P and the positive side first floating tube 127P inside the X guide 122. In this case, all or a portion of the negative side floating gas relay tube inside the negative side Y guide 132N and at least a portion of the negative side first floating tube 127N may not be provided on the negative side to which the first floating gas is not supplied.

In the gas pressure actuator 100 used in the vacuum chamber, it is necessary to prevent the first driving gas such as compressed air supplied to the servo chamber 150 and the first floating gas such as compressed air supplied to the air pad 170 from leaking into the vacuum chamber. Therefore, in the present embodiment, exhaust grooves 172, 174, and 176 for exhausting the first driving gas inside the servo chamber 150 and the first floating gas inside the air pad 170 outward of the vacuum chamber are provided on the inner peripheral surface of the X slider 124. As illustrated, the exhaust grooves 172, 174, and 176 are provided at positions where the servo chamber 150 and the air pad 170 are pinched from both the positive and negative sides in the X direction and the Y direction. In other words, the exhaust grooves 172, 174, and 176 are provided on the inner peripheral surface of the X slider 124 outside the servo chamber 150 and the air pad 170.

The exhaust grooves 172, 174, and 176 are provided such that the pressure sequentially decreases from the inside or the center toward the outside, that is, such that a degree of vacuum sequentially increases. For example, the exhaust groove 172 is set to the atmospheric pressure, the exhaust groove 174 is set to low vacuum, and the exhaust groove 176 is set to a medium vacuum. The exhaust grooves 172, 174, and 176 having different pressures or degrees of vacuum in this way are realized by a plurality of first exhaust tubes 129 (only one is illustrated for convenience in FIG. 2) provided inside the X guide 122 serving as the first driving shaft. Specifically, the first exhaust tube 129 communicating with the atmosphere or air at the atmospheric pressure is opened at a position facing the exhaust groove 172. In this manner, the exhaust groove 172 has the atmospheric pressure. The first exhaust tube 129 connected to a low vacuum pump (not illustrated) or the like is opened at a position facing the exhaust groove 174. In this manner, the exhaust groove 174 has a low vacuum. The first exhaust tube 129 connected to a medium vacuum pump (not illustrated) or the like is opened at a position facing the exhaust groove 176. In this manner, the exhaust groove 176 has a medium vacuum.

The first driving gas inside the servo chamber 150 and the first floating gas inside the air pad 170 are sequentially exhausted outward of the vacuum chamber through the atmospheric pressure (exhaust groove 172), the low vacuum (exhaust groove 174), and the medium vacuum (exhaust groove 176) by the plurality of exhaust grooves 172, 174, and 176 and the plurality of first exhaust tubes 129 as described above. Therefore, the first driving gas inside the servo chamber 150 and the first floating gas inside the air pad 170 are effectively prevented from leaking into the vacuum chamber.

The first exhaust tube 129 includes a positive side first exhaust tube 129P and a negative side first exhaust tube 129N. The positive side first exhaust tube 129P and the negative side first exhaust tube 129N are provided inside the X guide 122. However, as will be described later, the positive side Y guide 132P and the negative side Y guide 132N communicate with an exhaust relay tube provided inside the positive side Y guide 132P and the negative side Y guide 132N. Therefore, the first exhaust tube 129 exhausts the first driving gas and the first floating gas to the Y guide 132 serving as the second driving shaft provided with the exhaust relay tube. For example, the exhaust relay tubes in the Y guide 132 are respectively connected to the atmosphere, the low vacuum pump, and the medium vacuum pump to respectively realize the atmospheric pressure (exhaust groove 172), the low vacuum (exhaust groove 174), and the medium vacuum (exhaust groove 176) described above.

In this way, the gas from the exhaust groove 172 is exhausted to the atmosphere via the first exhaust tube 129 (129P and/or 129N) for the atmospheric pressure inside the X guide 122 and the exhaust relay tube for the atmospheric pressure inside the Y guide 132 (132P and/or 132N). Similarly, the gas from the exhaust groove 174 is exhausted via the first exhaust tube 129 (129P and/or 129N) for the low vacuum inside the X guide 122, the exhaust relay tube for the low vacuum inside the Y guide 132 (132P and/or 132N), and the low vacuum pump. Similarly, the gas from the exhaust groove 176 is exhausted via the first exhaust tube 129 (129P and/or 129N) for the medium vacuum inside the X guide 122, the exhaust relay tube for the medium vacuum inside the Y guide 132 (132P and/or 132N), and the medium vacuum pump.

The gas may be exhausted from the exhaust grooves 172, 174, and 176 on both the positive side and the negative side through the first exhaust tube 129 and the exhaust relay tube on any one of the positive side and the negative side. For example, the gas may be exhausted from the exhaust grooves 172, 174, and 176 on both the positive side and the negative side through the positive side first exhaust tube 129P inside the X guide 122 and the positive side exhaust relay tube inside the positive side Y guide 132P. In this case, at least a portion of the negative side first exhaust tube 129N and all or a portion of the negative side exhaust relay tube inside the negative side Y guide 132N may not be provided on the negative side where the gas is not exhausted.

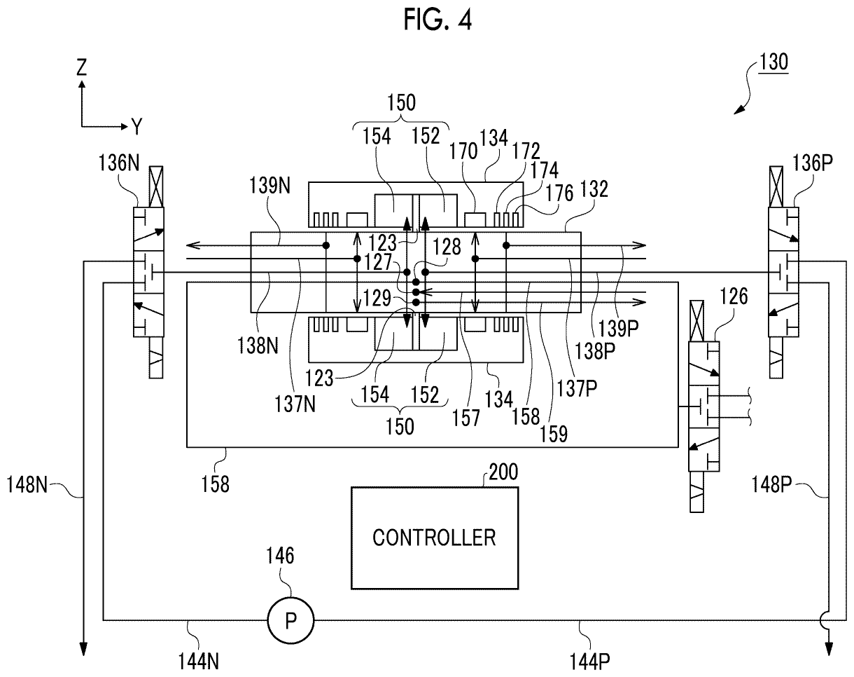

FIG. 4 is a section view schematically illustrating a basic configuration and operation of the Y actuator 130. Specifically, a YZ section at the center of the Y actuator 130 in the X direction is schematically illustrated. The same reference numerals will be assigned to the same configurations as those of the X actuator 120 illustrated in FIG. 2, and repeated description thereof will be omitted.

The Y actuator 130 includes a Y servo valve 136 that supplies a second driving gas (air or the like) having a pressure commanded by the controller 200 to the Y guide 132 and the Y slider 134. Specifically, the Y servo valve 136 supplies and exhausts the second driving gas to the servo chamber 150 serving as the internal space provided at the center of the Y slider 134 in the Y direction via the second driving tube 138 provided inside the Y guide 132.

The servo chamber 150 is partitioned by the pressure receiving plate 123 fixed to the Y guide 132 into a positive side servo chamber 152 on the positive side (right side in FIG. 4) in the Y direction and a negative side servo chamber 154 on the negative side (left side in FIG. 4) in the Y direction. The Y servo valve 136 includes a positive side Y servo valve 136P provided on the positive side in the Y direction to supply and exhaust the second driving gas to the positive side servo chamber 152, and a negative side Y servo valve 136N provided on the negative side in the Y direction to supply and exhaust the second driving gas to the negative side servo chamber 154. The positive side Y servo valve 136P communicates with the positive side servo chamber 152 via the positive side second driving tube 138P, and the negative side Y servo valve 136N communicates with the negative side servo chamber 154 via the negative side second driving tube 138N. The positive side Y servo valve 136P and the negative side Y servo valve 136N are configured in the same manner as the X servo valve 126 illustrated in FIG. 3, and control the supply amount and the exhaust amount of the second driving gas in the positive side servo chamber 152 and the negative side servo chamber 154 in accordance with the position of the spool.

The controller 200 controls the positive side Y servo valve 136P and the negative side Y servo valve 136N to generate a differential pressure (pressure difference) between the positive side servo chamber 152 and the negative side servo chamber 154. The Y slider 134 is driven in the Y direction along the Y guide 132 by this differential pressure.

The positive side second driving tube 138P and the negative side second driving tube 138N are provided inside the Y guide 132. For example, the positive side Y servo valve 136P and the negative side Y servo valve 136N are provided in both end portions of the Y guide 132 in the Y direction, and are respectively connected to the positive side second driving tube 138P and the negative side second driving tube 138N. In this way, the positive side Y servo valve 136P supplies and exhausts the positive side second driving gas to the positive side servo chamber 152 via the positive side second driving tube 138P inside the Y guide 132. Similarly, the negative side Y servo valve 136N supplies and exhausts the negative side second driving gas to the negative side servo chamber 154 via the negative side second driving tube 138N inside the Y guide 132.

As described above with reference to FIG. 2, the first driving tube 128 for supplying and exhausting the first driving gas for driving in the X direction to the servo chamber 150 and the X actuator 120 communicates with a driving gas relay tube 158 provided inside the Y guide 132 in FIG. 4. For example, the X servo valve 126 is provided in an end portion of at least one on the positive side and the negative side of the Y guide 132, and is connected to the driving gas relay tube 158. As illustrated in the example, the X servo valve 126 provided in the positive side end portion of the Y guide 132 may be connected to both the first driving gas relay tube 158 directed from the positive side end portion of the Y guide 132 toward the first driving tube 128 on the negative side, and the second driving gas relay tube 158 directed from the negative end portion of the Y guide 132 toward the first driving tube 128 on the positive side.

The positive side Y servo valve 136P for driving in the Y direction and the X servo valve 126 for driving in the X direction are jointly disposed in the positive side end portion of the Y guide 132 in the illustrated example. The X servo valve 126 supplies and exhausts the first driving gas to the servo chamber 150 in the X actuator 120 via the driving gas relay tube 158 inside the Y guide 132 and the first driving tube 128 inside the X guide 122. In this way, inside the Y guide 132 serving as the second driving shaft, the supply and exhaust of the second driving gas for driving in the Y direction through the second driving tube 138 and the supply and exhaust or the relay of the first driving gas for driving in the X direction through the driving gas relay tube 158 are simultaneously performed.

The positive side Y servo valve 136P and the negative side Y servo valve 136N are respectively connected to the pump 146 serving as a supply source of the air (positive side second driving gas and negative side second driving gas) via the positive side air supply tube 144P and the negative side air supply tube 144N. The pump 146 may be the same as, or may be different the pump 146 for the X actuator 120 illustrated in FIG. 2. In addition, the positive side Y servo valve 136P and the negative side Y servo valve 136N respectively exhaust the air (positive side second driving gas and negative side second driving gas) outward of the vacuum chamber (not illustrated) accommodating the gas pressure actuator 100, via the positive side exhaust tube 148P and the negative side exhaust tube 148N. The positive side Y servo valve 136P and the negative side Y servo valve 136N may be provided outside the vacuum chamber.

The positive side second driving gas from the pump 146 is supplied to the positive side servo chamber 152 via the positive side air supply tube 144P, the positive side Y servo valve 136P, and the positive side second driving tube 138P inside the Y guide 132. Similarly, the negative side second driving gas from the pump 146 is supplied to the negative side servo chamber 154 via the negative side air supply tube 144N, the negative side Y servo valve 136N, and the negative side second driving tube 138N inside the Y guide 132.

The positive side second driving gas inside the positive side servo chamber 152 is exhausted outward of the vacuum chamber via the positive side second driving tube 138P, the positive side Y servo valve 136P, and the positive side exhaust tube 148P inside the Y guide 132. Similarly, the negative side second driving gas inside the negative side servo chamber 154 is exhausted outward of the vacuum chamber via the negative side second driving tube 138N, the negative side Y servo valve 136N, and the negative side exhaust tube 148N inside the Y guide 132.

The air pad 170 serving as a static pressure bearing is formed between the outer peripheral surface of the Y guide 132 and the inner peripheral surface of the Y slider 134 such that the Y slider 134 can smoothly move along the Y guide 132 in the Y direction. The air pad 170 is formed in such a manner that the second floating gas such as the compressed air supplied through the second floating tube 137 provided inside the Y guide 132 serving as the second driving shaft is always supplied between the outer peripheral surface of the Y guide 132 and the inner peripheral surface of the Y slider 134. The Y slider 134 floated from the Y guide 132 by the air pad 170 can smoothly move without being substantially in-contact with the Y guide 132.

The plurality of air pads 170 are provided at positions where the servo chamber 150 provided at the center of the Y slider 134 in the Y direction is pinched from both the positive and negative sides in the Y direction and/or the X direction. In addition, the servo chamber 150 schematically illustrated in FIG. 4 actually extends over a stroke of the Y slider 134 in the Y direction, and may be pinched from both the positive and negative sides in the X direction by the pair of air pads 170 similarly extending in the Y direction. In addition, the plurality of air pads 170 are provided at positions where the Y guide 132 is pinched from both the positive and negative sides in the Z direction. The rotation of the Y slider 134 around the X axis is effectively suppressed by the symmetrical disposition of the plurality of air pads 170 in the Y direction and the Z direction.

The second floating tube 137 includes a positive side second floating tube 137P and a negative side second floating tube 137N. The positive side second floating tube 137P and the negative side second floating tube 137N are provided inside the Y guide 132. The second floating tubes 137 are connected to a pump (pump 146 may be shared) (not illustrated) serving as the supply source of the second floating gas, which is the same as the pump 146 serving as the supply source of the second driving gas. In this way, the positive side second floating gas from the pump (not illustrated) is supplied to the air pad 170 on the positive side in the Y direction via the positive side second floating tube 137P inside the Y guide 132. Similarly, the negative side second floating gas from the pump (not illustrated) is supplied to the air pad 170 on the negative side in the Y direction via the negative side second floating tube 137N inside the Y guide 132.

The second floating gas may be supplied from the second floating tubes 137 on any one of the positive side and the negative side to the air pads 170 on both the positive side and the negative side. For example, the second floating gas from the pump (not illustrated) may be supplied to the air pads 170 on both the positive side and the negative side via the positive side second floating tube 137P inside the Y guide 132. In this case, at least a portion of the negative side second floating tube 137N may not be provided on the negative side where the second floating gas is not supplied.

As described above with reference to FIG. 2, the first floating tube 127 for supplying the first floating gas to the air pad 170 in the X actuator 120 communicates with the floating gas relay tube 157 provided inside the Y guide 132 in FIG. 4. The floating gas relay tube 157 is connected to a pump (pump 146 may be shared) (not illustrated) serving as the supply source of the first floating gas. The first floating gas from the pump (not illustrated) is supplied to the air pad 170 in the X actuator 120 via the first floating gas relay tube 157 inside the Y guide 132 and the first floating tube 127 inside the X guide 122. In this way, inside the Y guide 132 serving as the second driving shaft, the supply of the second floating gas for floating the Y slider 134 through the second floating tube 137, and the supply or the relay of the first floating gas for floating the X slider 124 through the floating gas relay tube 157 are simultaneously performed.

The inner peripheral surface of the Y slider 134 is provided with exhaust grooves 172, 174, and 176 for exhausting the second driving gas inside the servo chamber 150 and the second floating gas inside the air pad 170 outward of the vacuum chamber. As illustrated, the exhaust grooves 172, 174, and 176 are provided at positions where the servo chamber 150 and the air pad 170 are pinched from both the positive and negative sides in the Y direction and the X direction. In other words, the exhaust grooves 172, 174, and 176 are provided on the inner peripheral surface of the Y slider 134 outside the servo chamber 150 and the air pad 170.

The exhaust grooves 172, 174, and 176 are provided such that the pressure sequentially decreases from the inside or the center toward the outside, that is, such that the degree of vacuum sequentially increases. For example, the exhaust groove 172 is set to the atmospheric pressure, the exhaust groove 174 is set to low vacuum, and the exhaust groove 176 is set to a medium vacuum. The exhaust grooves 172, 174, and 176 having different pressures or degrees of vacuum in this way are realized by the plurality of second exhaust tubes 139 (only one is illustrated for convenience in FIG. 4) provided inside the Y guide 132 serving as the second driving shaft. Specifically, the exhaust groove 172 is opened at a position facing the second exhaust tube 139 that communicates with the atmosphere or the air at atmospheric pressure. In this manner, the exhaust groove 172 has the atmospheric pressure. The exhaust groove 174 is opened at a position facing the second exhaust tube 139 connected to a low vacuum pump (not illustrated). In this manner, the exhaust groove 174 has the low vacuum. The exhaust groove 176 is opened at a position facing the second exhaust tube 139 connected to a medium vacuum pump (not illustrated). In this manner, the exhaust groove 176 has the medium vacuum.

The second driving gas inside the servo chamber 150 and the second floating gas inside the air pad 170 are sequentially exhausted outward of the vacuum chamber through the atmospheric pressure (exhaust groove 172), the low vacuum (exhaust groove 174), and the medium vacuum (exhaust groove 176) by the plurality of exhaust grooves 172, 174, and 176 and the plurality of second exhaust tubes 139 as described above. Therefore, the second driving gas inside the servo chamber 150 and the second floating gas inside the air pad 170 are effectively prevented from leaking into the vacuum chamber.

The second exhaust tube 139 includes a positive side second exhaust tube 139P and a negative side second exhaust tube 139N. The positive side second exhaust tube 139P and the negative side second exhaust tube 139N are provided inside the Y guide 132. For example, the second exhaust tubes 139 are respectively connected to the atmosphere, the low vacuum pump, and the medium vacuum pump to realize the atmospheric pressure (exhaust groove 172), the low vacuum (exhaust groove 174), and the medium vacuum (exhaust groove 176) described above.

In this way, the gas from the exhaust groove 172 is exhausted to the atmosphere via the second exhaust tube 139 (139P and/or 139N) for the atmospheric pressure inside the Y guide 132. Similarly, the gas from the exhaust groove 174 is exhausted via the second exhaust tube 139 (139P and/or 139N) for low vacuum inside the Y guide 132 and the low vacuum pump. Similarly, the gas from the exhaust groove 176 is exhausted via the second exhaust tube 139 (139P and/or 139N) for the medium vacuum inside the Y guide 132 and the medium vacuum pump.

The gas may be exhausted from the exhaust grooves 172, 174, and 176 on both the positive side and the negative side through the second exhaust tubes 139 on any one of the positive side and the negative side. For example, the gas may be exhausted from the exhaust grooves 172, 174, and 176 on both the positive side and the negative side through the positive side second exhaust tube 139P inside the Y guide 132. In this case, at least a portion of the negative side second exhaust tube 139N may not be provided on the negative side where the gas is not exhausted.

As described above with reference to FIG. 2, the first exhaust tube 129 that exhausts the first driving gas and the first floating gas from the exhaust grooves 172, 174, and 176 in the X actuator 120 communicates with the exhaust relay tube 159 provided inside the Y guide 132 in FIG. 4. For example, the exhaust relay tubes 159 are respectively connected to the atmosphere, the low vacuum pump, and the medium vacuum pump to realize the atmospheric pressure (exhaust groove 172 in FIG. 2), the low vacuum (exhaust groove 174 in FIG. 2), and the medium vacuum (exhaust groove 176 in FIG. 2) described above.

In this way, the exhaust gas (first driving gas and first floating gas) from the exhaust groove 172 in the X actuator 120 is exhausted to the atmosphere via the first exhaust tube 129 (129P and/or 129N) for the atmospheric pressure inside the X guide 122 and the exhaust relay tube 159 for the atmospheric pressure inside the Y guide 132. Similarly, the exhaust gas (first driving gas and first floating gas) from the exhaust groove 174 in the X actuator 120 is exhausted via the first exhaust tube 129 (129P and/or 129N) for the low vacuum inside the X guide 122, the exhaust relay tube 159 for the low vacuum inside the Y guide 132, and the low vacuum pump. Similarly, the exhaust gas (first driving gas and first floating gas) from the exhaust groove 176 in the X actuator 120 is exhausted via the first exhaust tube 129 (129P and/or 129N) for the medium vacuum inside the X guide 122, the exhaust relay tube 159 for the medium vacuum inside the Y guide 132, and the medium vacuum pump.

As described above, inside the Y guide 132 serving as the second driving shaft, the exhaust (atmospheric pressure/low vacuum/medium vacuum) of the Y actuator 130 through the second exhaust tube 139 and the exhaust (atmospheric pressure/low vacuum/medium vacuum) of the X actuator 120 through the exhaust relay tube 159 are simultaneously performed. In FIG. 4, for convenience, the second exhaust tube 139 and the exhaust relay tube 159 are illustrated as separate bodies. However, since the purpose of the exhaust (atmospheric pressure/low vacuum/medium vacuum) is common, the second exhaust tube 139 and the exhaust relay tube 159 may be integrally formed (the low vacuum pump and the medium vacuum pump connected to the second exhaust tube 139 and the exhaust relay tube 159 can be used in common). In order to indicate this configuration, hereinafter, when necessary, the second exhaust tube 139 and/or the exhaust relay tube 159 will be referred to as the second exhaust tube 139/159.

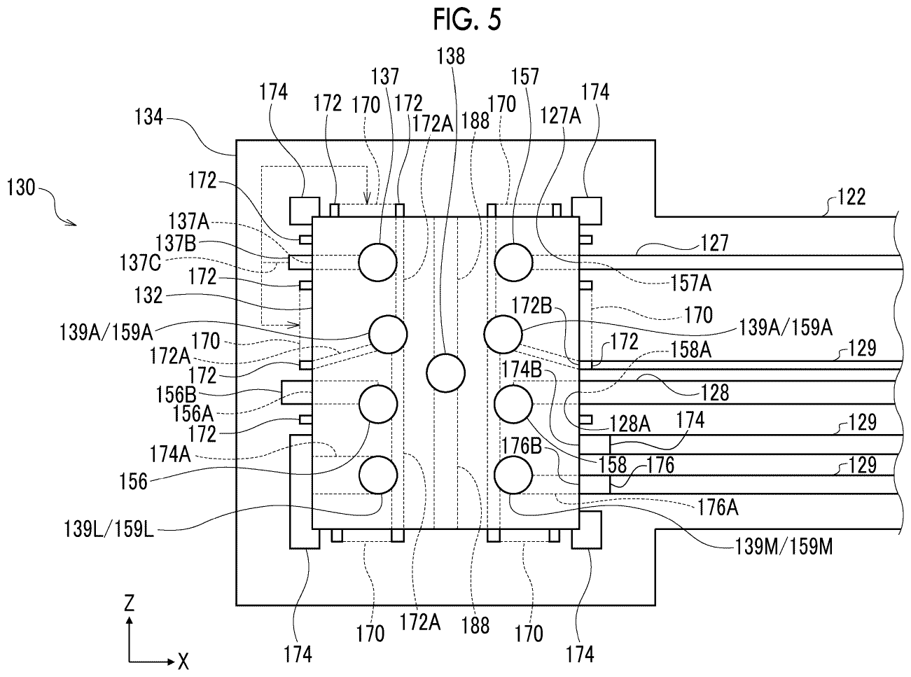

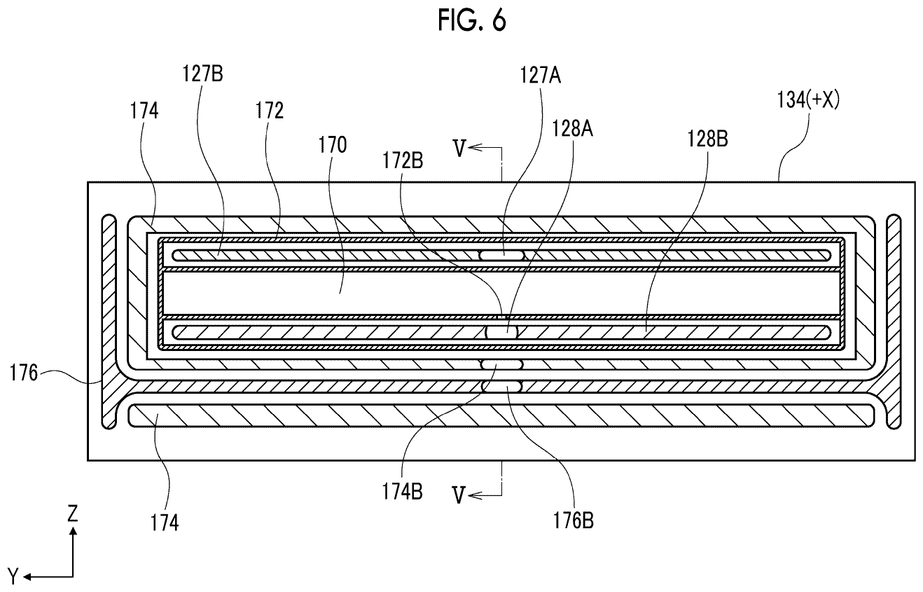

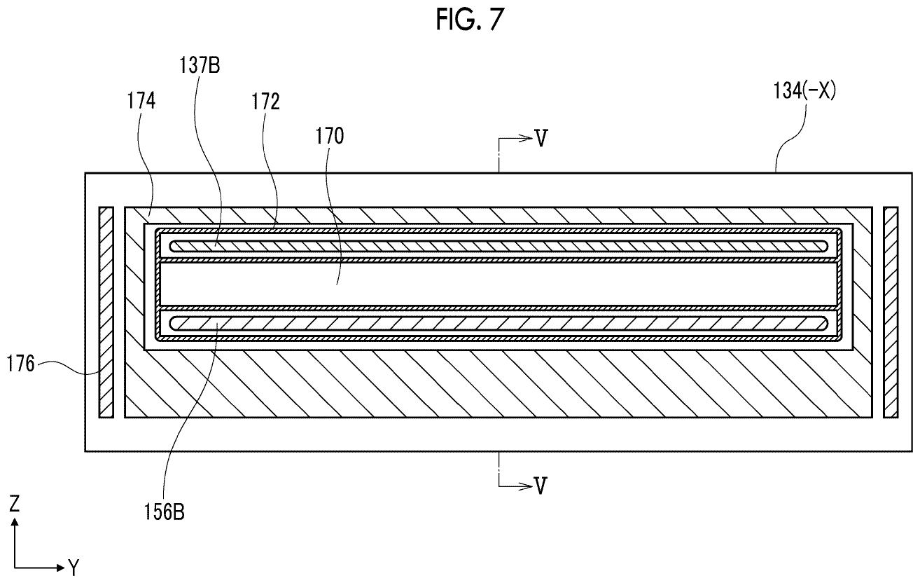

FIG. 5 is a ZX section view of a portion of the Y actuator 130 and the X guide 122. FIG. 6 is a side view illustrating an inner peripheral surface (surface facing the Y guide 132) on the +X side of the Y slider 134. FIG. 7 is a side view illustrating an inner peripheral surface (surface facing the Y guide 132) on the −X side of the Y slider 134. FIG. 5 illustrates a section taken along line V-V at the center in the Y direction of FIGS. 6 and 7.

As illustrated in FIG. 5, the Y slider 134 is provided to surround the rectangular Y guide 132 from four sides. Nine tubes extending in the Y direction are provided in the Y guide 132 serving as the second driving shaft. Specifically, the second driving tube 138 to which the second driving gas for generating the driving force in the Y direction by the Y actuator 130 is supplied, the driving gas relay tube 158 to which the first driving gas for generating the driving force in the X direction by the X actuator 120 is supplied, an auxiliary gas tube 156 (to be described later), the second floating tube 137 to which the second floating gas for floating the Y slider 134 from the Y guide 132 is supplied, the floating gas relay tube 157 to which the first floating gas for floating the X slider 124 from the X guide 122 is supplied, two atmospheric opening tubes 139A/159A open to the atmosphere, low vacuum tubes 139L/159L connected to the low vacuum pump, and medium vacuum tubes 139M/159M connected to the medium vacuum pump in the second exhaust tubes 139/159 for exhausting the first floating gas, the second floating gas, the first driving gas, and the second driving gas extend in the Y direction inside the Y guide 132. The nine tubes described above are symmetrically disposed in view of a balance of the pressure applied from the Y guide 132 to the Y slider 134 in the X direction and/or the Z direction.

In the example in FIG. 5, the second driving tube 138 is disposed substantially at the center of the Y guide 132. As schematically illustrated in FIG. 4, the second driving tube 138 branches to branch tubes 188 in the +Z direction and the −Z direction at a central portion of the Y guide 132 in the Y direction, and faces the servo chamber 150 (not illustrated in FIG. 5) located in each direction. In order to take the balance in the X direction and the Z direction when the Y actuator 130 is driven in the Y direction by the servo chamber 150 of the Y actuator 130, it is preferable that the second driving tube 138 is disposed at the center of the Y guide 132 in the X direction and the Z direction. In order to avoid interference with the branch tube 188 disposed at the center of the Y guide 132 in the X direction, the eight tubes other than the second driving tube 138 are disposed in line symmetry with respect to the branch tube 188, four on the +X side and four on the −X side.

The driving gas relay tube 158 and the auxiliary gas tube 156 are respectively disposed in line symmetry with respect to the branch tube 188 at the center of the Y guide 132 in the X direction, on the +X side and the −X side at substantially the same position in the Z direction.

The driving gas relay tube 158 supplies the first driving gas to the first driving tube 128 from a driving gas relay tube opening 158A which is an opening with respect to the first driving tube 128 extending inside the X guide 122 serving as the first driving shaft. Here, a slight gap of several um is present between the Y guide 132 and the Y slider 134 due to a static pressure bearing. Therefore, there is a possibility that a portion of the first driving gas exiting in the +X direction from the driving gas relay tube opening 158A presses the Y slider 134 in the +X direction after flowing into the gap between the Y guide 132 and the Y slider 134 without entering the first driving tube opening 128A of the first driving tube 128. However, even in this case, the auxiliary gas tube 156 (to be described later) can cause the auxiliary gas having the same pressure to flow into the same gap in the −X direction from the auxiliary tube opening 156A on the opposite side to the driving gas relay tube opening 158A in the X direction. Therefore, the balance between the pressure in the +X direction by the driving gas relay tube 158 and the pressure in the −X direction by the auxiliary gas tube 156 is effectively taken.

In addition, as illustrated in FIG. 6, a first driving groove 128B which is a groove including a first driving tube opening 128A and extending in the Y direction is provided on the inner peripheral surface of the Y slider 134 on the +X side. The first driving groove 128B extends to include a movable range in the Y direction of the driving gas relay tube opening 158A when the Y slider 134 moves in the Y direction with respect to the Y guide 132. As a result, the driving gas relay tube opening 158A is opened with respect to the first driving groove 128B regardless of the position of the Y slider 134 in the Y direction. In other words, even when the position of the driving gas relay tube opening 158A in the Y direction of the Y guide 132 is changed in accordance with the movement of the Y slider 134, the driving gas relay tube opening 158A is always located somewhere inside the first driving groove 128B. Therefore, the first driving gas exiting from the driving gas relay tube opening 158A in the +X direction enters the first driving tube opening 128A at the substantially center in the Y direction via the first driving groove 128B. However, when the first driving gas enters the first driving groove 128B from the driving gas relay tube opening 158A, the first driving gas presses the Y slider 134 in the +X direction.

As described above, the first driving gas exiting in the +X direction from the driving gas relay tube opening 158A of the Y guide 132 presses the Y slider 134 in the +X direction. The auxiliary gas tube 156 disposed in line symmetry with respect to the driving gas relay tube 158 and the branch tube 188 is provided to apply the pressure in the −X direction to the Y slider 134 in order to at least partially offset the pressure in the +X direction applied to the Y slider 134 by the driving gas relay tube 158.

The auxiliary gas such as the compressed air having the pressure substantially equal to that of the first driving gas supplied to the driving gas relay tube 158 is supplied to the auxiliary gas tube 156. The auxiliary gas tube 156 exhausts the auxiliary gas to the outside of the Y guide 132 in the −X direction from the auxiliary tube opening 156A which is an opening on a side opposite to the driving gas relay tube opening 158A in the X direction. The auxiliary tube opening 156A on the −X side is disposed symmetrically with respect to the driving gas relay tube opening 158A on the +X side. In other words, the positions of the auxiliary tube opening 156A and the driving gas relay tube opening 158A in the Y direction and the Z direction are substantially equal to each other.

As illustrated in FIG. 7, an auxiliary groove 156B which is a groove extending in the Y direction is provided on the inner peripheral surface of the Y slider 134 on the −X side. The shape of the auxiliary groove 156B on the −X side is substantially the same as the shape of the first driving groove 128B disposed symmetrically on the +X side. The auxiliary groove 156B extends to include a movable range of the auxiliary tube opening 156A in the Y direction when the Y slider 134 moves in the Y direction with respect to the Y guide 132. As a result, the auxiliary tube opening 156A is opened with respect to the auxiliary groove 156B regardless of the position of the Y slider 134 in the Y direction. In other words, even when the position of the auxiliary tube opening 156A in the Y direction of the Y guide 132 is changed in accordance with the movement of the Y slider 134, the auxiliary tube opening 156A is always located somewhere inside the auxiliary groove 156B. Therefore, the auxiliary gas exiting from the auxiliary tube opening 156A in the −X direction enters the auxiliary groove 156B. When the auxiliary gas enters the auxiliary groove 156B from the auxiliary tube opening 156A, the auxiliary gas presses the Y slider 134 in the −X direction.

As described above, the auxiliary gas exiting from the auxiliary tube opening 156A of the Y guide 132 in the −X direction presses the Y slider 134 in the −X direction. Therefore, the pressure in the +X direction applied to the Y slider 134 by the first driving gas exiting from the driving gas relay tube opening 158A of the Y guide 132 in the +X direction is at least partially offset. In particular, the pressures of the auxiliary gas and the first driving gas are substantially equal to each other, and the configurations of the auxiliary groove 156B and the first driving groove 128B which receive the pressures of the respective gases are substantially equal to each other. Therefore, the balance between the pressure in the +X direction by the driving gas relay tube 158 and the pressure in the −X direction by the auxiliary gas tube 156 is effectively taken.

The floating gas relay tube 157 and the second floating tube 137 are respectively disposed in line symmetry with respect to the branch tube 188 at the center in the X direction of the Y guide 132, on the +X side and the −X side, at substantially the same position in the Z direction.

The floating gas relay tube 157 supplies the first floating gas to the first floating tube 127 from the floating gas relay tube opening 157A which is an opening with respect to the first floating tube 127 extending inside the X guide 122 serving as the first driving shaft. Here, a slight gap of several um is present between the Y guide 132 and the Y slider 134 due to a static pressure bearing. Therefore, there is a possibility that a portion of the first floating gas exiting in the +X direction from the floating gas relay tube opening 157A presses the Y slider 134 in the +X direction after flowing into the gap between the Y guide 132 and the Y slider 134 without entering the first floating tube opening 127A of the first floating tube 127. However, even in this case, the second floating tube 137 (to be described later) can cause the second floating gas having the same pressure to flow into the same gap in the −X direction from the second floating tube opening 137A on the side opposite to the floating gas relay tube opening 157A in the X direction. Therefore, the balance between the pressure in the +X direction by the floating gas relay tube 157 and the pressure in the −X direction by the second floating tube 137 is effectively taken.

In addition, as illustrated in FIG. 6, a first floating groove 127B which is a groove including the first floating tube opening 127A and extending in the Y direction is provided on the inner peripheral surface of the Y slider 134 on the +X side. The first floating groove 127B extends to include a movable range of the floating gas relay tube opening 157A in the Y direction when the Y slider 134 moves in the Y direction with respect to the Y guide 132. As a result, the floating gas relay tube opening 157A is opened with respect to the first floating groove 127B regardless of the position of the Y slider 134 in the Y direction. In other words, even when the position of the floating gas relay tube opening 157A of the Y guide 132 in the Y direction is changed in accordance with the movement of the Y slider 134, the floating gas relay tube opening 157A is always located somewhere inside the first floating groove 127B. Therefore, the first floating gas exiting from the floating gas relay tube opening 157A in the +X direction enters the first floating tube opening 127A at the substantially center in the Y direction via the first floating groove 127B. However, when the first floating gas enters the first floating groove 127B from the floating gas relay tube opening 157A, the first floating gas presses the Y slider 134 in the +X direction.

As described above, the first floating gas exiting in the +X direction from the floating gas relay tube opening 157A of the Y guide 132 presses the Y slider 134 in the +X direction. The second floating tube 137 disposed in line symmetry with respect to the floating gas relay tube 157 and the branch tube 188 is provided to apply the pressure in the −X direction to the Y slider 134 in order to at least partially offset the pressure in the +X direction applied to the Y slider 134 by the floating gas relay tube 157.

The second floating gas such as the compressed air having the pressure substantially equal to that of the first floating gas supplied to the floating gas relay tube 157 is supplied to the second floating tube 137. The second floating tube 137 exhausts the second floating gas to the outside of the Y guide 132 in the −X direction from the second floating tube opening 137A which is an opening on the side opposite to the floating gas relay tube opening 157A in the X direction. The second floating tube opening 137A on the −X side is disposed symmetrically with respect to the floating gas relay tube opening 157A on the +X side. In other words, the positions of the second floating tube opening 137A and the floating gas relay tube opening 157A in the Y direction and the Z direction are substantially equal to each other.

As illustrated in FIG. 7, a second floating groove 137B which is a groove extending in the Y direction is provided on the inner peripheral surface of the Y slider 134 on the −X side. The shape of the second floating groove 137B on the −X side is substantially the same as the shape of the first floating groove 127B disposed symmetrically on the +X side. The second floating groove 137B extends to include a movable range of the second floating tube opening 137A in the Y direction when the Y slider 134 moves in the Y direction with respect to the Y guide 132. As a result, the second floating tube opening 137A is opened with respect to the second floating groove 137B regardless of the position of the Y slider 134 in the Y direction. In other words, even when the position of the second floating tube opening 137A of the Y guide 132 in the Y direction is changed in accordance with the movement of the Y slider 134, the second floating tube opening 137A is always located somewhere inside the second floating groove 137B. Therefore, the second floating gas exiting from the second floating tube opening 137A in the-X direction enters the second floating groove 137B. When the second floating gas enters the second floating groove 137B from the second floating tube opening 137A, the second floating gas presses the Y slider 134 in the −X direction.

As described above, the second floating gas exiting from the second floating tube opening 137A of the Y guide 132 in the-X direction presses the Y slider 134 in the −X direction. Therefore, the pressure in the +X direction applied to the Y slider 134 by the first floating gas exiting from the floating gas relay tube opening 157A of the Y guide 132 in the +X direction is at least partially offset. In particular, the pressures of the second floating gas and the first floating gas are substantially equal to each other, and the configurations of the second floating groove 137B and the first floating groove 127B which receive the pressures of the respective gases are substantially equal to each other. Therefore, the balance between the pressure in the +X direction by the floating gas relay tube 157 and the pressure in the −X direction by the second floating tube 137 is effectively taken.

As schematically illustrated in FIG. 5, the second floating gas entering the second floating groove 137B from the second floating tube opening 137A is distributed to the plurality of air pads 170 provided on the respective inner peripheral surfaces of the Y slider 134 on the +X side, the −X side, the +Z side, and the −Z side through one or a plurality of floating gas distribution holes 137C provided on a bottom surface (surface on the −X side) of the second floating groove 137B. Here, the air pad 170 on the +X side and the air pad 170 on the-X side directly face each other in the X direction. Therefore, the pressure in the X direction received by the Y slider 134 is substantially offset by the second floating gases respectively ejected to the Y guide 132. Similarly, the two air pads 170 on the +Z side and the two air pads 170 on the −Z side directly face each other in the Z direction. Therefore, the pressure in the Z direction received by the Y slider 134 is substantially offset by the second floating gases respectively ejected to the Y guide 132.

The two atmospheric opening tubes 139A/159A open to the atmosphere are respectively disposed in line symmetry with respect to the branch tube 188 at the center of the Y guide 132 in the X direction, on the +X side and the −X side, at substantially the same position in the Z direction. The respective atmospheric opening tubes 139A/159A are disposed inside in the X direction of the other tubes 137, 156, 139L/159L, 157, 158, and 139M/159M in the Y guide 132 such that an atmospheric pressure tube 172A extending in the +Z direction and the −Z direction from the respective atmospheric opening tubes 139A/159A does not interfere with the other tubes 137, 156, 139L/159L, 157, 158, and 139M/159M in the Y guide 132.

In the respective atmospheric opening tubes 139A/159A, the exhaust grooves 172 respectively provided on the inner peripheral surface of the Y slider 134 on the +X side, the −X side, the +Z side, and the −Z side are decompressed to the atmospheric pressure through the atmospheric pressure tubes 172A respectively extending to the +X side, the −X side, the +Z side, and the −Z side. As illustrated in FIGS. 6 and 7, the exhaust groove 172 is formed to surround a location where various gases are supplied on the respective inner peripheral surfaces of the Y slider 134. Specifically, the exhaust groove 172 is formed to surround each of the air pad 170 (FIGS. 6 and 7) to which the second floating gas is supplied, the first driving tube opening 128A and the first driving groove 128B (FIG. 6) to which the first driving gas is supplied, the first floating tube opening 127A and the first floating groove 127B (FIG. 6) to which the first floating gas is supplied, the auxiliary groove 156B (FIG. 7) to which the auxiliary gas is supplied, and the second floating groove 137B (FIG. 7) to which the second floating gas is supplied. Various types of gases supplied to the respective inner peripheral surfaces of the Y slider 134 are effectively exhausted to the atmosphere by the exhaust groove 172.

In addition, in order to realize the same atmospheric pressure exhaust in the same exhaust groove 172 (FIG. 2) in the X slider 124, an atmospheric pressure opening 172B (FIG. 6) communicating with the first exhaust tube 129 (FIG. 5) extending inside the X guide 122 serving as the first driving shaft is provided at the substantially center of the exhaust groove 172 in the Y direction on the inner peripheral surface of the Y slider 134 on the +X side. Through the atmospheric pressure opening 172B, the first exhaust tube 129 of the X guide 122 and the exhaust groove 172 of the X slider 124 are decompressed to the atmospheric pressure.

The low vacuum tubes 139L/159L connected to the low vacuum pump and the medium vacuum tubes 139M/159M connected to the medium vacuum pump are respectively disposed in line symmetry with respect to the branch tube 188 at the center of the Y guide 132 in the X direction, on the +X side and the −X side, at substantially the same position in the Z direction.

In the low vacuum tubes 139L/159L, the exhaust grooves 174 provided on the respective inner peripheral surfaces of the Y slider 134 on the +X side, the −X side, the +Z side, and the −Z side are decompressed to the low vacuum through the low vacuum tube 174A extending to the −X side. As illustrated in FIGS. 6 and 7, the exhaust groove 174 is formed to surround the exhaust groove 172 open to the atmosphere on the respective inner peripheral surfaces of the Y slider 134. The low vacuum exhaust following the atmospheric pressure exhaust by the exhaust groove 172 is realized by the exhaust groove 174.

In addition, in order to realize the same low vacuum exhaust in the same exhaust groove 174 (FIG. 2) in the X slider 124, a low vacuum opening 174B (FIG. 6) communicating with the first exhaust tube 129 (FIG. 5) extending inside the X guide 122 serving as the first driving shaft is provided at the substantially center of the exhaust groove 174 in the Y direction on the inner peripheral surface on the +X side of the Y slider 134. Through the low vacuum opening 174B, the first exhaust tube 129 of the X guide 122 and the exhaust groove 174 of the X slider 124 are decompressed to the low vacuum.

In the medium vacuum tubes 139M/159M, the exhaust grooves 176 provided on the respective inner peripheral surfaces of the Y slider 134 on the +X side, the −X side, the +Z side, and the −Z side are decompressed to the medium vacuum through the medium vacuum tube 176A extending to the +X side. As illustrated in FIGS. 6 and 7, the exhaust groove 176 is formed to surround the exhaust groove 174 in the low vacuum on the respective inner peripheral surfaces of the Y slider 134. The medium vacuum exhaust following the low vacuum exhaust by the exhaust groove 174 is realized by the exhaust groove 176.

In addition, in order to realize the same medium vacuum exhaust in the same exhaust groove 176 (FIG. 2) in the X slider 124, a medium vacuum opening 176B (FIG. 6) communicating with the first exhaust tube 129 (FIG. 5) extending inside the X guide 122 serving as the first driving shaft is provided at the substantially center of the exhaust groove 176 in the Y direction on the inner peripheral surface of the Y slider 134 on the +X side. Through the medium vacuum opening 176B, the first exhaust tube 129 of the X guide 122 and the exhaust groove 176 of the X slider 124 are decompressed to the medium vacuum.

According to the present embodiment as described above, the supply and the exhaust of various gases in the X guide 122 serving as the first driving shaft can be performed via the Y guide 132 serving as the second driving shaft. Therefore, a variable tube as a movable component that is likely to deteriorate does not need to be used for supplying and exhausting the gas in the X guide 122 and/or the X slider 124. A risk of contamination in the vacuum environment can be reduced, and a frequency of maintenance work can be reduced.

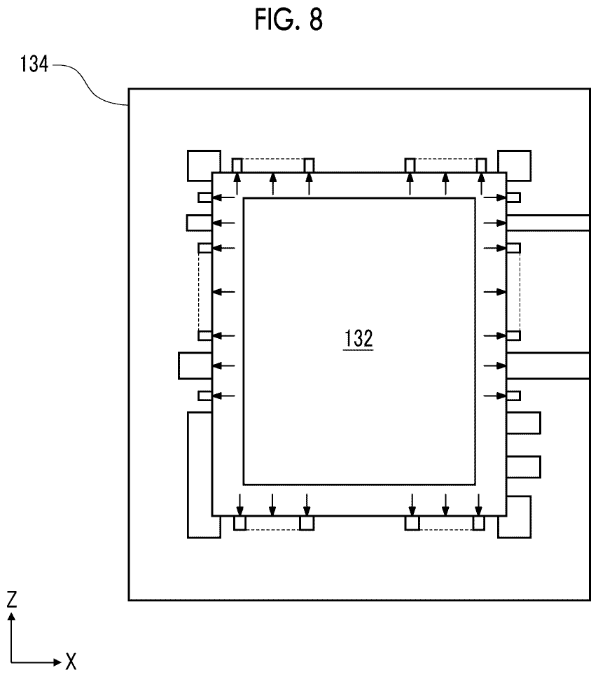

In addition, as schematically illustrated in FIG. 8 similar to FIG. 5, the pressure (schematically illustrated by an arrow) applied to the Y slider 134 by various gases supplied via the Y guide 132 is balanced in both the X direction and the Z direction. Therefore, the Y slider 134 can be smoothly driven in the Y direction. In the present embodiment, the balance of the pressure in the X direction and the Z direction between the Y guide 132 and the Y slider 134 is realized by various gases. However, a portion of these gases (for example, the auxiliary gas supplied by the auxiliary gas tube 156) may be replaced with means for generating a non-contact repulsive force such as magnets of the same polarity.

Hitherto, the present invention has been described, based on the embodiment. Combinations of the respective components and the respective processes in the embodiment as an example can be modified in various ways, and it is obvious to those skilled in the art that the modifications are included in the scope of the present invention.

In addition, the configuration, the operation, and the function of each device and each method which are described in the embodiment can be implemented by hardware resources or software resources, or by cooperation between the hardware resources and the software resources. For example, a processor, a ROM, a RAM, and various integrated circuits can be used as the hardware resources. For example, programs such as operating systems and applications can be used as the software resources.

The present invention relates to a gas pressure driving device or the like.

It should be understood that the invention is not limited to the above-described embodiment, but may be modified into various forms on the basis of the spirit of the invention. Additionally, the modifications are included in the scope of the invention.

What is claimed is:

1. A gas pressure driving device comprising:
a first driving shaft that drives a driven body in a first direction by a pressure of a gas; and
a second driving shaft that drives the driven body in a second direction intersecting with first direction by the pressure of the gas,
wherein the first driving shaft drives the driven body in the first direction by the gas supplied through an inside of the first driving shaft and the second driving shaft.

2. The gas pressure driving device according to claim 1,
wherein a first driving tube to which a first driving gas for generating a driving force in the first direction by the first driving shaft is supplied is provided inside the first driving shaft, and
a second driving tube to which a second driving gas for generating a driving force in the second direction by the second driving shaft is supplied, and a driving gas relay tube to which the first driving gas is supplied, the driving gas relay tube supplying the first driving gas to the first driving tube from a driving gas relay tube opening which is an opening with respect to the first driving tube, are provided inside the second driving shaft.

3. The gas pressure driving device according to claim 2, further comprising:
a slider driven in the second direction integrally with the first driving shaft along the second driving shaft,
wherein a first driving tube opening which is an opening of the first driving tube is provided on a surface facing the second driving shaft in the slider.

4. The gas pressure driving device according to claim 3,
wherein a first driving groove which is a groove including the first driving tube opening and extending in the second direction is provided on a surface facing the second driving shaft in the slider, and
the driving gas relay tube opening is open with respect to the first driving groove regardless of a position of the slider in the second direction.

5. The gas pressure driving device according to claim 3,
wherein an auxiliary gas tube that exhausts an auxiliary gas to an outside of the second driving shaft from an auxiliary tube opening which is an opening on a side opposite to the driving gas relay tube opening in the first direction is provided inside the second driving shaft.

6. The gas pressure driving device according to claim 5,
wherein an auxiliary groove which is a groove extending in the second direction is provided in a surface facing the second driving shaft in the slider, and
the auxiliary tube opening is open with respect to the auxiliary groove regardless of a position of the slider in the second direction.

7. The gas pressure driving device according to claim 5,
wherein a pressure of the auxiliary gas exiting from the auxiliary tube opening and a pressure of the first driving gas exiting from the driving gas relay tube opening are substantially equal to each other.

8. The gas pressure driving device according to claim 3,
wherein a first floating tube to which a first floating gas for floating the driven body from the first driving shaft is supplied is provided inside the first driving shaft, and
a second floating tube to which a second floating gas for floating the slider from the second driving shaft is supplied, and a floating gas relay tube to which the first floating gas is supplied, the floating gas relay tube supplying the first floating gas to the first floating tube from a floating gas relay tube opening which is an opening with respect to the first floating tube, are provided inside the second driving shaft.

9. The gas pressure driving device according to claim 8,
wherein the second floating tube exhausts the second floating gas to an outside of the second driving shaft from a second floating tube opening which is an opening on a side opposite to the floating gas relay tube opening in the first direction.

10. The gas pressure driving device according to claim 9,
wherein a first floating tube opening which is an opening of the first floating tube and a first floating groove which is a groove including the first floating tube opening and extending in the second direction are provided in a surface facing the second driving shaft in the slider, and
the floating gas relay tube opening is open with respect to the first floating groove regardless of a position of the slider in the second direction.

11. The gas pressure driving device according to claim 10,
wherein a second floating groove which is a groove extending in the second direction is provided in a surface facing the second driving shaft in the slider, and
the second floating tube opening is open with respect to the second floating groove regardless of a position of the slider in the second direction.

12. The gas pressure driving device according to claim 8,
wherein a first exhaust tube that exhausts the first floating gas to the second driving shaft is provided inside the first driving shaft, and
a second exhaust tube that exhausts the second floating gas to an outside of the second driving shaft, and an exhaust relay tube that exhausts the first floating gas from the first exhaust tube to the outside of the second driving shaft are provided inside the second driving shaft.

13. The gas pressure driving device according to claim 12,
wherein the second exhaust tube and the exhaust relay tube are the same tube.

14. The gas pressure driving device according to claim 12,
wherein a plurality of exhaust grooves for exhausting the first driving gas, the second driving gas, the first floating gas, and the second floating gas to the outside are provided on an inner peripheral surface of the slider.

15. The gas pressure driving device according to claim 3, further comprising:
a servo valve that supplies the first driving gas and the second driving gas having a pressure commanded by a controller to the slider.

16. A positioning device that positions the driven body by the gas pressure driving device according to claim 1.

17. A processing device that performs predetermined processing on the driven body positioned by the positioning device according to claim 16.

18. A device manufacturing method for manufacturing a device through the processing performed by the processing device according to claim 17.
